(19) United States
(12) Patent Application Publication
(10) Pub. No.: US 2006/0062943 A1
(43) Pub. Date: Mar. 23, 2006

(54) Single-unit tubular vacuum packing bags

(76) Inventor: Sung Ho Lee, Anyang-City (KR)

Correspondence Address: Sung Ho Lee, 10771 EL Caballo Ave, San Diego, CA, 92127, US

(21) Appl. No.: 10/944,383

(22) Filed: Sep. 17, 2004

(51) Int. Cl. B31B 45/00

(52) U.S. Cl. 428/34.1; 428/36.9; 428/43

(57) ABSTRACT

A tubular element for forming vacuum-packing bags that preserve material in vacuum. The tubular element includes a tube and a plurality of linings. The tube has an inside surface and an outside surface, and is configured as a single unit extending longitudinally. The tube is pressed and compacted into a compact form so that the tubular element can be relatively easily packaged and transported. The tube can be cut into a plurality of tubes of desired lengths, and one end of each of the plurality of tubes can be sealed to form an enclosure so that material to be preserved can be placed in the enclosure. The plurality of linings extends along the inside surface of the tube, and provides channels for evacuating, by suction, of air from the enclosure.

### BACKGROUND

The present invention relates to vacuum packing material, and more specifically, to a single-unit tubular vacuum packing bags.

Vacuum packing bags are often used to preserve material, such as food, by evacuating air from the inside of the bags. The vacuum packing bags are generally made of synthetic material such as plastic.

A conventional method of manufacturing the vacuum bag include first stacking two or more sheets of synthetic material that are cut into a rectangular shape (or any other shape suitable for constituting a vacuum bag) and then sealing three of the four sides, as shown in FIGS. 1 and 2.

FIG. 1 illustrates a conventional method of manufacturing vacuum packing bag with two sheets of synthetic material 100, 102 cut into a rectangular shape 104. The two sheets are then sealed on three sides 200, 202, 204, as shown in FIG. 2. Accordingly, material such as food may be inserted into the enclosure 208 of the bag, air may then be evacuated from the bag, and the fourth side 206 of the bag can be sealed to preserve the material.

Although the conventional process for manufacturing the vacuum packing bag, as described above, is adequate for producing a bag appropriate for the intended purpose, the process has drawbacks that need improving. The conventional process involves relatively complex steps of cutting the sheets 100, 102 into a desired shape 104, laying the appropriate number of sheets 100, 102 in a substantially matching layer, and sealing three 200, 202, 204 of the four sides. Further, sealing the sides 200, 202, 204 may significantly reduce the usable space of the enclosure 208.

### SUMMARY

In one implementation, a tubular element for forming vacuum-packing bags that preserve material in vacuum is described. The tubular element includes a tube and a plurality of linings. The tube has an inside surface and an outside surface, and is configured as a single unit extending longitudinally. The tube is pressed and compacted into a compact form so that the tubular element can be relatively easily packaged and transported. The tube can be cut into a plurality of tubes of desired lengths, and one end of each of the plurality of tubes can be sealed to form an enclosure so that material to be preserved can be placed in the enclosure. The plurality of linings extends along the inside surface of the tube, and provides channels for evacuating, by suction, of air from the enclosure.

In another implementation, a tubular element for forming vacuum-packing bags that preserve material in vacuum is described. The tubular element includes a tube and a plurality of linings. Tube has an inside surface and an outside surface, and is separated into multiple units of desired lengths by a plurality of seals such that the multiple units can be cut so that each unit would include one seal from the plurality of seals at one end to form an enclosure so that material to be preserved can be placed in the enclosure. The plurality of linings extends along the inside surface of the tube, and provides channels for evacuating, by suction, of air from the enclosure.

### BRIEF DESCRIPTION OF THE DRAWINGS

FIG. 1 illustrates a conventional method of manufacturing a vacuum packing bag with two sheets of synthetic material cut into a rectangular shape.

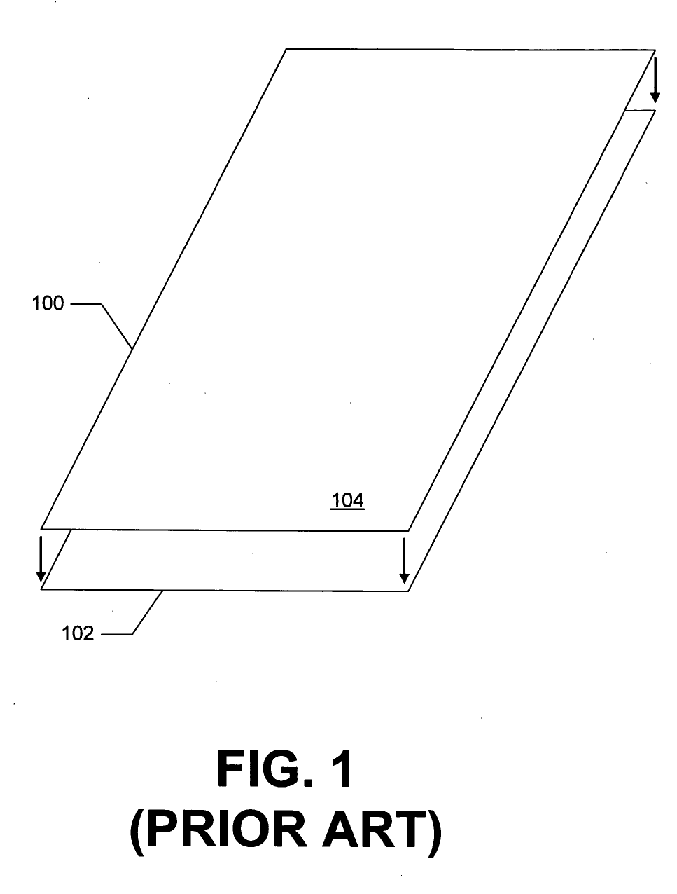

FIG. 2 illustrates the conventional method of manufacturing a vacuum packing bag where the two sheets are sealed on three sides.

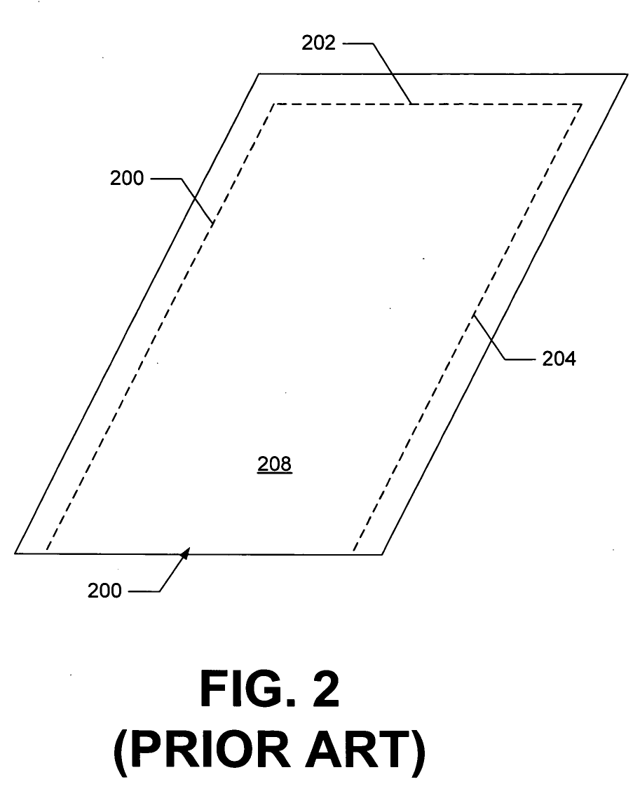

FIG. 3 shows one implementation of a vacuum packing bag manufactured as a single-unit tube.

FIG. 4 illustrates a further advantage of manufacturing the vacuum packing bag into a single-unit tube.

FIG. 5 shows one example of cutting the long single-unit tube into a desired length.

FIG. 6 illustrates another implementation of the vacuum packing bag manufactured as a single-unit tube, wherein the vacuum packing bag includes a plurality of linings extending along the length of the single-unit tube, and is intended to provide channels for facilitating evacuation, by suction, of air from the enclosure.

FIG. 7 illustrates another implementation of the vacuum packing bag described above.

### DETAILED DESCRIPTION

Although the conventional process for manufacturing the vacuum packing bag, as described above, is adequate for producing a bag appropriate for the intended purpose, the process involves relatively complex steps of cutting the sheets 100, 102 into a desired shape 104, laying the appropriate number of sheets 100, 102 in a substantially matching layer, and sealing three 200, 202, 204 of the four sides. Further, sealing the sides 200, 202, 204 may significantly reduce the usable space of the enclosure 208.

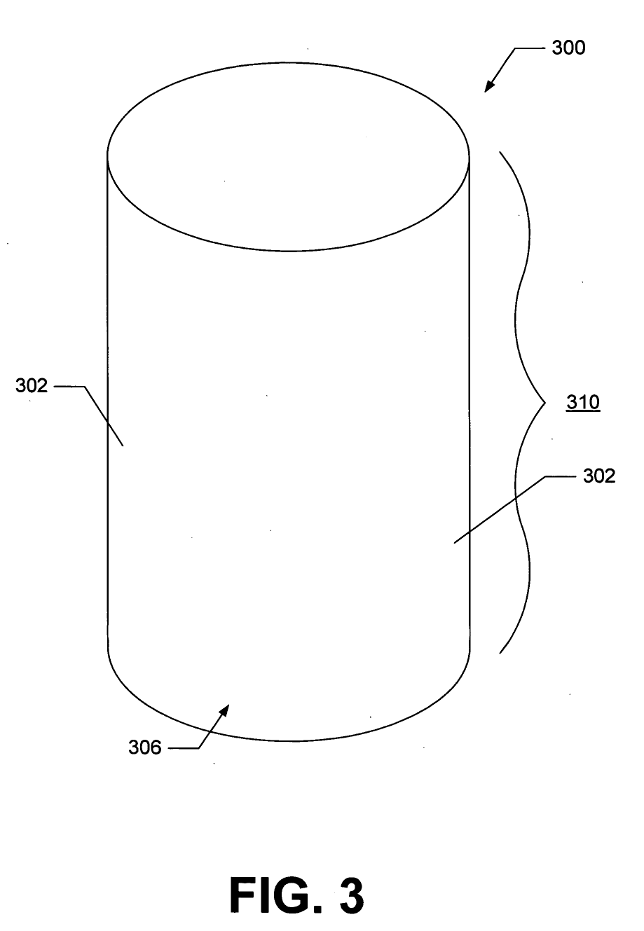

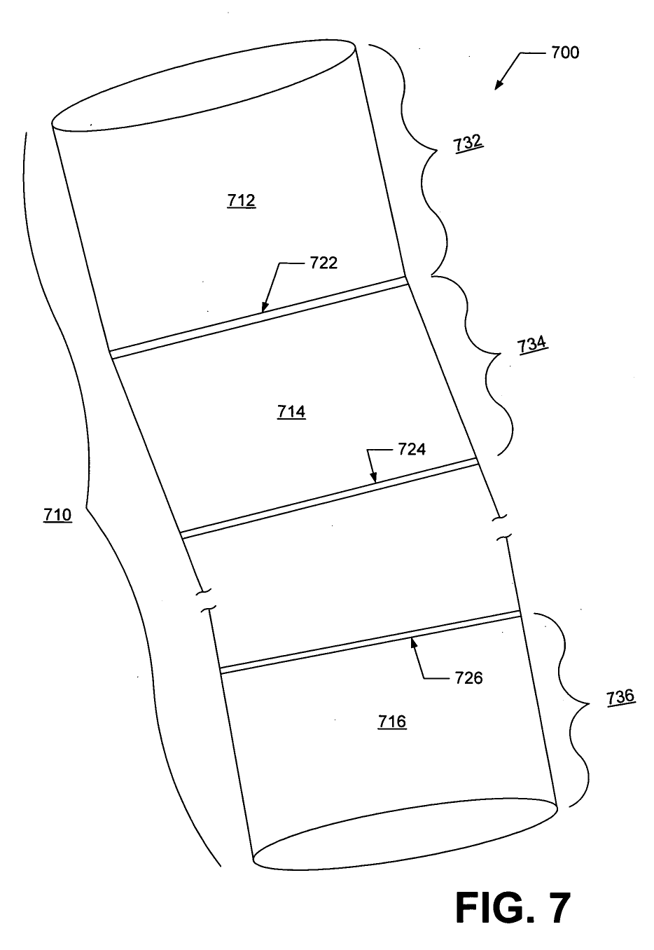

This disclosure describes a vacuum packing bag that addresses the drawbacks of the vacuum packing bags manufactured using the conventional process. In particular, various implementations of the vacuum packing bag manufactured as a single-unit tube are described (see FIG. 3). However, the described bag can be manufactured as a multi-unit tube, in which the tube is divided into multiple units by sealing the tube width-wise at certain lengths (see FIG. 7).

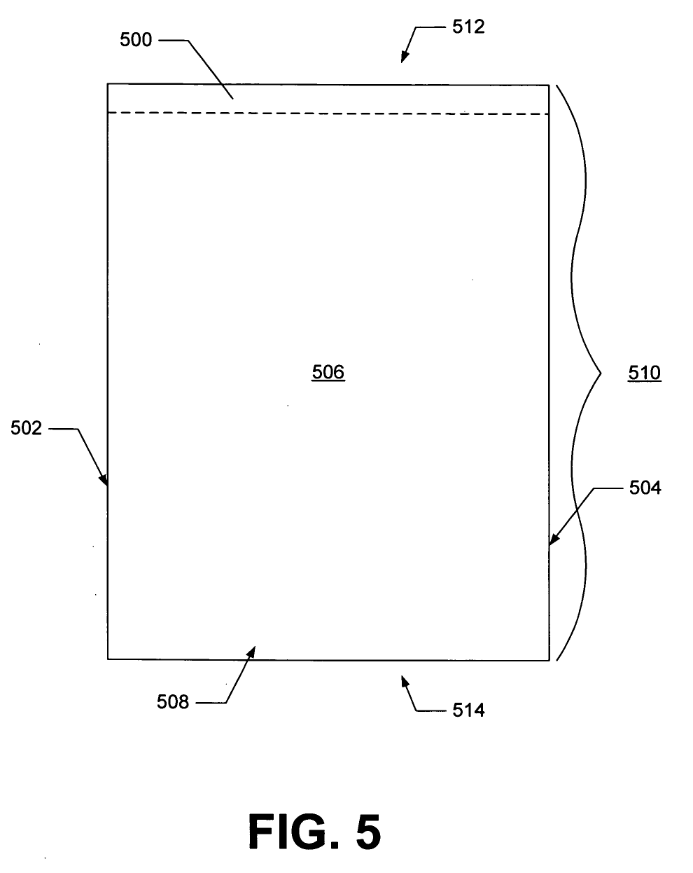

FIG. 3 shows one implementation of a vacuum packing bag 300 manufactured as a single-unit tube. The bag 300 is configured into a singular tube of a particular length 310 so that the bag 300 can be cut to a desired length and sealed in the width-wise direction, by means of bonding, as shown in FIG. 5.

In the illustrated implementation of FIG. 3, the vacuum packing bag 300 does not need to be tapered or sealed on the longitudinal sides 302, 304 because the bag 300 is manufactured as a single unit tube. This cuts down on the number of steps needed in the manufacturing process and also provides larger enclosure space 306 for the bag 300 than when the enclosure 208 is formed using multiple sheets and the sides 200, 202, 204 are sealed.

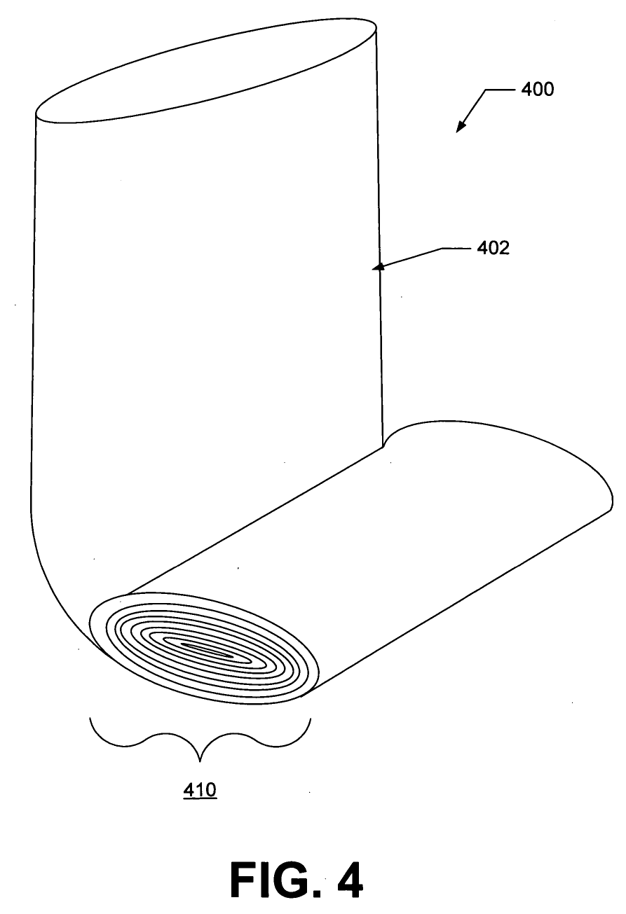

FIG. 4 illustrates a further advantage of manufacturing the vacuum packing bag 400 into a single-unit tube. As shown in FIG. 4, the long single-unit tube 402 can be pressed and rolled into a compact roll 410 so that it can be easily packaged and transported. The compact roll 410 also allows the vacuum packing bag 400 to be easily placed on store shelves. Consumers can buy the roll, cut the roll of single-unit tube into a plurality of tubes of desired lengths, seal one end of each of the plurality of tubes, place the material to be preserved into the enclosure created by the sealing of the one end of each tube, and “vacuum seal” the other end of each tube. The term “vacuum seal” refers to first evacuating the air in the enclosure and then sealing the other end.

FIG. 5 shows one example of cutting the long single-unit tube into a desired length 510. Once the tube is cut, there will be two open ends 512, 514. One end 500 is sealed to form an enclosure 506. It should be noted that the two sides 502, 504 are not open, and therefore, do not need to be sealed. Material to be preserved is placed in the enclosure 506 and the other end 508 is then vacuum sealed.

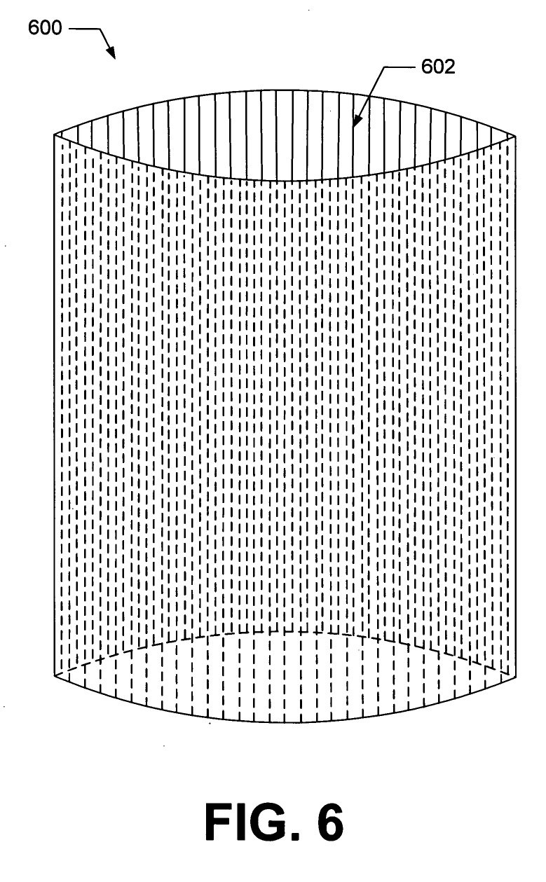

FIG. 6 illustrates another implementation of the vacuum packing bag 600 manufactured as a single-unit tube. The vacuum packing bag 600 includes a plurality of linings 602 extending along the inside surface of the single-unit tube, and is intended to provide channels for facilitating evacuation, by suction, of air from the enclosure.

FIG. 7 illustrates another implementation of the vacuum packing bag 700 described above. In the illustrated implementation, the vacuum packing bag 700 is manufactured as a multi-unit tube 710, in which the tube 710 is divided into a plurality of units 712, 714, 716 by sealing the tube width-wise 722, 724, 726 at certain length intervals 732, 734, 736. The length intervals 732, 734, 736 at which the tube 700 is sealed can be fixed or dynamically adjusted. Therefore, this implementation substantially eliminates for the consumer one additional step of sealing one end of the tube 710 before placing the material to be preserved into the enclosure 712, 714, 716 of the bag 700.

Although various illustrative implementations of the present invention have been described, one of ordinary skill in the art will see that additional implementations are also possible and within the scope of the present invention. For example, while the single-unit tube 402 in FIG. 4 is rolled into a compact roll, the tube 402 can be configured into a compact form by other means, such as folding the tube 402 into a stack.

For another example, although FIG. 6 shows the linings 602 extending longitudinally along the inside surface of the single-unit tube, the linings 602 can be formed on the inside surface with other patterns, such as a diagonal pattern.

Accordingly, the present invention is not limited to only those implementations described above.

What is claimed is:

1. A tubular element for forming vacuum-packing bags that preserve material in vacuum, comprising:
a tube having an inside surface and an outside surface, said tube configured as a single unit extending longitudinally, said tube pressed and compacted into a compact form so that the tubular element can be relatively easily packaged and transported, said tube formed from synthetic material,
wherein said tube can be cut into a plurality of tubes of desired lengths, and one end of each of the plurality of tubes can be sealed to form an enclosure so that material to be preserved can be placed in the enclosure; and
a plurality of linings extending along the inside surface of said tube, said plurality of linings providing channels for evacuating, by suction, of air from the enclosure.

2. The tubular element of claim 1, wherein the compact form includes a roll.

3. The tubular element of claim 1, wherein said plurality of linings extends longitudinally.

4. The tubular element of claim 1, wherein said desired lengths of said plurality of tubes are dynamically varied.

5. The tubular element of claim 1, wherein said desired lengths of said plurality of tubes are fixed.

6. A tubular element for forming vacuum-packing bags that preserve material in vacuum, comprising:
a tube having an inside surface and an outside surface, said tube separated into multiple units of desired lengths by a plurality of seals such that said multiple units can be cut so that each unit would include one seal from said plurality of seals at one end to form an enclosure so that material to be preserved can be placed in the enclosure,
wherein said tube is formed from synthetic material; and
a plurality of linings extending along the inside surface of said tube, said plurality of linings providing channels for evacuating, by suction, of air from the enclosure.
